(19) United States
(12) Patent Application Publication
(10) Pub. No.: US 2019/0359154 A1
(43) Pub. Date: Nov. 28, 2019

(54) VEHICLE AND CONTROL METHOD THEREOF

(71) Applicants: HYUNDAI MOTOR COMPANY, Seoul (KR); KIA MOTORS CORPORATION, Seoul (KR); YURA CORPORATION CO., LTD., Seongnam-si (KR)

(72) Inventors: Hyunwook KIM, Seoul (KR); SangJae HAN, Hwaseong-si (KR); Chan Young JUNG, Seongnam-si (KR); Jong Seok LIM, Seongnam-si (KR)

(21) Appl. No.: 16/198,622

(22) Filed: Nov. 21, 2018

(30) Foreign Application Priority Data
May 28, 2018 (KR) 10-2018-0060174

(51) Int. Cl. B60R 16/033; G06F 1/3296; H02J 7/00

(52) U.S. Cl. CPC B60R 16/033; H02J 2007/0067; H02J 7/0063; G06F 1/3296

(57) ABSTRACT

A vehicle includes a battery; a sensor configured to sense a state of the battery and the vehicle; at least one electronic device configured to receive power from the battery; a communicator configured to communicate with the electronic device; and a controller configured to determine whether the state of the vehicle satisfies a second condition when the sensed state of the battery satisfies a first condition, and stops the operation of the communicator when the state of the vehicle satisfies the second condition.

### CROSS-REFERENCE TO RELATED APPLICATION

This application is based on and claims priority under 35 U.S.C. § 119 to Korean Patent Application No. 10-2018-0060174, filed on May 28, 2018 in the Korean Intellectual Property Office, the disclosure of which is incorporated by reference in its entirety.

### BACKGROUND

### 1. Field

Embodiments of the present disclosure relate to a vehicle and a control method thereof, and more particularly, to a technology for efficiently controlling an electronic device to lower the possibility of discharge when there is a possibility of a battery discharge of the vehicle.

### 2. Description of the Related Art

In modern society, vehicles are the most common means of transportation and the number of people using vehicles is ever increasing. The development of vehicle technologies is changing and facilitating traveling over long distances with increased convenience.

A battery of the vehicle is a primary component in driving the vehicle. When a driver rotates a key after inserting the key into a key box, the battery may supply power necessary various electronic devices of the vehicle and to rotate motors of the vehicle. When the operation of the vehicle is started, electricity may be generated by driving a generator using a rotational force of an engine, and the remaining electricity may be charged into the battery.

When the vehicle is driving, electric and electronic devices of the vehicle may be driven using the power generated by the engine rotational power of the vehicle, and the electric and electronic devices of the vehicle are powered using only the power charged in the battery when the vehicle is stopped. Further, in a state in which the vehicle is powered off, a user may supply the power necessary for starting the vehicle.

### SUMMARY

An aspect of the present disclosure provides a vehicle that can efficiently use a battery of the vehicle by reducing unnecessary current consumption that occurs during stopping of the vehicle.

Additional aspects of the disclosure will be set forth in part in the description which follows and, in part, will be obvious from the description, or may be learned by practice of the disclosure.

In accordance with an aspect of the present disclosure, a vehicle includes: a battery; a sensor configured to sense a state of the battery and the vehicle; at least one electronic device configured to receive power from the battery; a communicator configured to communicate with the electronic device; and a controller configured to determine whether the state of the vehicle satisfies a second condition when the state of the battery satisfies a first condition, and stops the operation of the communicator when determined that the state of the vehicle satisfies the second condition.

The controller may turn off the power of the electronic device.

The controller may stop different types of the electronic devices according to the state of the battery.

The sensor may sense the state of the battery when the power of the vehicle is turned off.

The controller may determine whether the second condition is satisfied based on at least one selected from the group consisting of a power state of the vehicle, a state of a remote control device, and/or a state of a door.

The controller may determine that the vehicle satisfies the second condition when the vehicle is not in an accessory (ACC) state, and ignition 1 (IGN1) and ignition 2 (IGN2) states are OFF.

The controller may determine that the vehicle satisfies the second condition when the state of the remote control device is in a locked state and the door is closed.

The controller may determine that the vehicle satisfies the second condition when the vehicle is not in the accessory (ACC) state, the ignition 1 (IGN1) and ignition 2 (IGN2) states are OFF, the state of the remote control device is in a locked state, and the door is closed.

The first condition may be generated based on at least one selected from the group consisting of the remaining amount of the battery, an elapsed time after the power of the vehicle is turned off, and/or the amount of a current flowing after the power of the vehicle is turned off.

The controller may turn on the power of the communicator when the door of the vehicle is unlocked by a remote control device of the vehicle or when the door of the vehicle is opened.

In accordance with another aspect of the present disclosure, a control method of a vehicle including at least one electronic device that is supplied power from a battery, the method includes: sensing a state of the battery; sensing a state of the vehicle when the state of the battery is determined to satisfy a first condition; and preventing communication with the electronic device when the state of the vehicle is determined to satisfy a second condition.

The method may further include: stopping an operation of the electronic device when the state of the battery is included in a predetermined reference.

The stopping of the operation of the electronic device may include stopping different types of the electronic devices according to the state of the battery.

The sensing of the state of the battery may include sensing the state of the battery when the power of the vehicle is turned off.

The determining of the state of the vehicle satisfying the second condition may include determining whether the second condition is satisfied based on at least one of the power state of the vehicle, a state of a remote control device, and/or a state of a door.

The determining of the state of the vehicle satisfying the second condition may include determining that the vehicle satisfies the second condition when the vehicle is not in an accessory (ACC) state, and ignition 1 (IGN1) and ignition 2 (IGN2) states are OFF.

The determining of the state of the vehicle satisfying the second condition may include determining that the vehicle satisfies the second condition when the state of the remote control device is in a locked state and the door is closed.

The determining of the state of the vehicle satisfying the second condition may include determining that the vehicle satisfies the second condition when the vehicle is not in the accessory (ACC) state, the ignition 1 (IGN1) and ignition 2 (IGN2) states are OFF, the state of the remote control device is in a locked state, and the door is closed.

The first condition may be generated based on at least one of the remaining amount of the battery, an elapsed time after the power of the vehicle is turned off, and/or the amount of a current flowing after the power of the vehicle is turned off.

The method may further include: turning on the power of the communicator when the door of the vehicle is unlocked by a remote control device of the vehicle or when the door of the vehicle is opened.

In a further aspect provides a method of controlling CAN (controlled area network) communication with electronic devices in a vehicle when the vehicle is not operating. The method may comprise sensing a state of the battery; sensing a state of the vehicle when the state of the battery is determined to satisfy a first condition; and disconnect CAN (controlled area network) communication with the electronic device when the state of the vehicle is determined to satisfy a second condition. In embodiments, the first condition is met when the state of the battery is below a preset charge level, and the second condition is met when the vehicle is parked over a preset period of time.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view explaining a process of generating a dark current in a typical vehicle;

FIG. 2 is a view illustrating an exterior of a vehicle according to an embodiment;

FIG. 3 is a view illustrating an interior of the vehicle according to an embodiment;

FIG. 4 is a block diagram illustrating some components of the vehicle according to an embodiment;

FIG. 5 is a block diagram illustrating some components of the vehicle according to another embodiment;

FIG. 6 is a flowchart illustrating a method of controlling the vehicle according to an embodiment;

FIG. 7 is a flowchart illustrating the method of controlling the vehicle according to another embodiment; and

FIG. 8 is a view comparing the dark current flowing in the vehicle according to an embodiment and the typical vehicle.

### DETAILED DESCRIPTION

Embodiments described herein and configurations illustrated in the accompanying drawings are only certain examples of the present disclosure, and various modifications may be made at the time of filing of the present application to replace the embodiments and drawings of the present specification.

In addition, terms used herein are intended to only describe certain embodiments, and shall by no means restrict and/or limit the present disclosure. Unless clearly used otherwise, expressions in a singular form include the meaning in a plural form.

In the present specification, terms such as “comprising,” “having” or “including” are intended to designate the presence of characteristics, numbers, steps, operations, elements, parts or combinations thereof, and shall not be construed to preclude any possibility of presence or addition of one or more other characteristics, numbers, steps, operations, elements, parts or combinations thereof. In addition, although terms including ordinal numbers such as “first” or “second” may be used herein to describe various elements, the elements should not be limited by such terms.

Embodiments of the present disclosure will now be described in detail with reference to the accompanying drawings to be readily practiced by a person of ordinary skill in the art. In the drawings, portions irrelevant to the description will not be shown in order to clearly describe the present disclosure.

As vehicle technologies develop, many electronic devices are mounted in the vehicle, and the generator of the vehicle that is powered by a cigar jack of the vehicle may also be gradually increasing its capacity in accordance with the trends.

However, when many electronic devices are used simultaneously or the amount of electricity consumed by using the electronic devices with high power consumption exceeds the capacity of the generator, the electricity charged in the battery cannot satisfy the required amount of electricity, and a discharge phenomenon in which power is not performed may occur.

In addition, when the outdoor temperature is significantly low, such as in winter, or when the battery is discharged due to a very small current flowing in an electronic device that continuously operates, such as a clock, or when the battery has a short life and the electromotive force is low, the battery cannot supply sufficient electric power to the vehicle, and the driver may not be able to start the engine.

In some vehicles, an interface central controller (ICU) sequentially blocks the electronic devices installed in the vehicle based on the battery information received from a battery sensor, thereby reducing unnecessary current consumption that may occur during stopping of the vehicle.

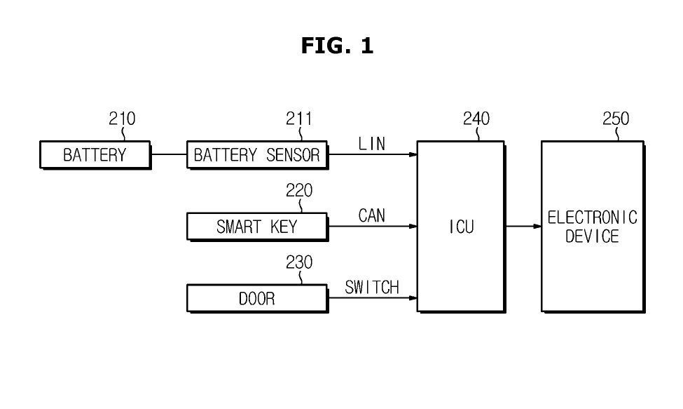

Referring to FIG. 1, when the vehicle is stopped, a battery sensor 211 may periodically sense a battery 210 and transmit the sensed result to an ICU 240 through LIN (Local Interconnect Network) communication. Also, in the stopping state, when the ICU receives a signal from an external device such as the battery sensor 211, the ICU may operate all CAN (controlled area network) communication capable of communicating with electronic devices 250 to turn on the electronic devices provided in the vehicle.

At this time, all the electronic devices of the vehicle instantaneously switch from the OFF state to the ON state, and the battery may consume a lot of current consumption instantaneously. As the amount of the current consumed increases, the possibility of the discharging the vehicle is high.

The ICU 240 may also receive the signal from a smart key 220 through the CAN communication as well as the battery sensor 211 and receive the signal from the switch when doors of the vehicle are closed or open, which may also cause the above-mentioned discharging.

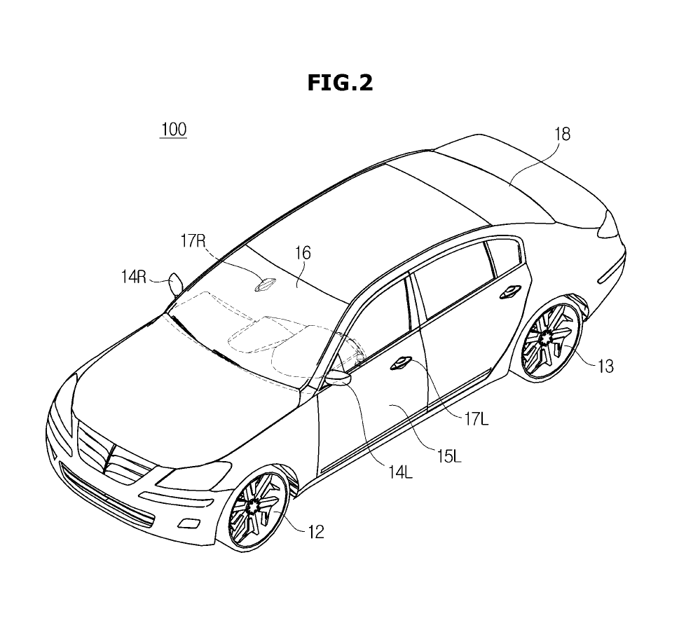

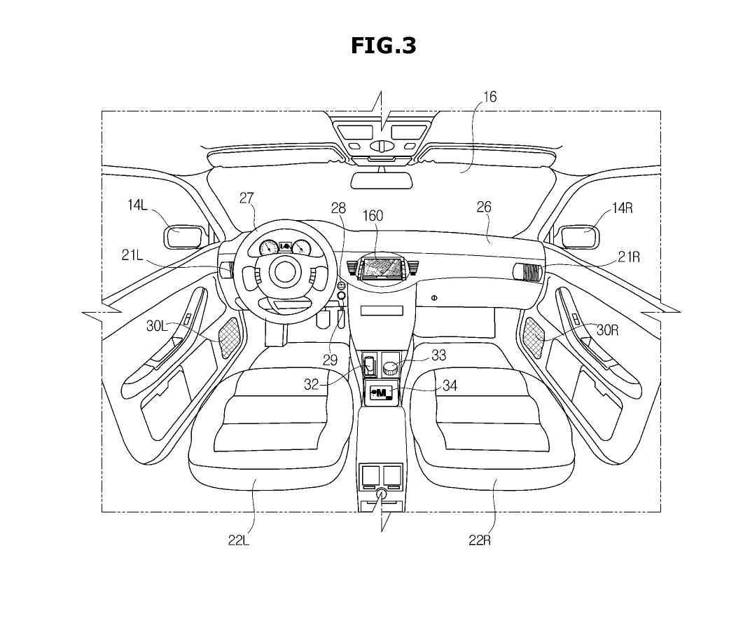

FIG. 2 is a view illustrating an exterior of a vehicle 100 according to an embodiment, and FIG. 3 is a view illustrating an interior of the vehicle 100 according to an embodiment. Hereinafter, the description will be made with reference to FIGS. 1 and 2 in order to avoid redundancy in the description of the same content.

Referring to FIG. 2, In embodiments, the exterior of the vehicle 100 may include wheels 12 and 13 for moving the vehicle 100, doors 15L and 15R for shielding the interior of the vehicle 100 from the outside, a front window 16 providing a view ahead of the vehicle 100, side mirrors 14L and 14R providing a view of areas behind and to the sides of the vehicle 100.

In embodiments, the wheels 12 and 13 may include the front wheels 12 disposed in a front portion of the vehicle 100 and the rear wheels 13 disposed in a rear portion of the vehicle 100. A driving system may be arranged inside the vehicle 100 for providing a rotational force to the front wheels 12 or the rear wheels 13 to move the vehicle 100 forward or backward. The driving system may employ an electric motor that produces the rotational force from electrical power supplied from a storage battery, or a combustion engine that burns a fuel to create the rotational force.

In embodiments, the doors 15L and 15R are pivotally attached onto the left and right sides of the vehicle 100, and opened to provide access into the vehicle 100 and closed for shielding the interior of the vehicle 100 from the outside. Handles 17L and 17R may be mounted on the outer surface of the vehicle 100 to open or close the doors 15L and 15R.

The front window 16 is mounted on the upper front part of the main body to provide views ahead of the vehicle 100.

The side mirrors 14L and 14R include the left side mirror 14L and the right side mirror 14R disposed on the left and right sides of the vehicle 100, respectively, for providing views behind and to the sides of the vehicle 100.

In addition, in embodiments, the vehicle 100 may include a sensor configured to sense an obstruction or other vehicles behind or to the sides of the vehicle 100 (e.g., subject vehicle). The sensor may include a sensing device, such as an approximation sensor, a rainfall sensor configured to sense precipitation and whether it is raining, etc.

One or more proximity sensors may receive a reflection signal reflected from an obstruction or another vehicle located around the vehicle. The one or more proximity sensors may be configured to transmit sensing signals from the side or rear of the vehicle 100. Based on the waveform of the received reflection signal, a controller of the vehicle 100 may be configured to determine whether there is another vehicle or obstruction behind and to the sides of the vehicle 100 and where the vehicle or obstruction is located. For example, the proximity sensor may be configured to sense a distance to the obstruction by irradiating ultrasounds or infrared rays and receiving the reflected ultrasounds or infrared rays from the obstacles.

Referring to FIG. 3, in the center area of a dashboard 26, a display 160 may be provided for displaying video or images provided by an Audio Video Navigation (AVN) terminal. The display 160 may be configured to selectively display at least one of audio, video, and navigation screens, and in addition, display various control screens related to the vehicle 100 or screens related to additional functions.

In embodiments, the display 160 may be implemented with Liquid Crystal Displays (LCDs), Light Emitting Diodes (LEDs), Plasma Display Panels (PDPs), Organic Light Emitting Diodes (OLEDs), Cathode Ray Tubes (CRTs), or the like, and may include a touch screen panel allowing the user to input a touch-based command.

Furthermore, a center inputter or input device 33 of a jog shuttle type may be mounted between a driver's seat 22L and a passenger seat 22R. The user may input a control command by turning or pressing (or otherwise engaging) the center inputter 33 or pushing the center inputter 33 to the left, right, up or down (e.g., manipulating the unit).

A speaker 30 is configured to output sound and may be mounted inside the vehicle 100. The speaker 30 may be configured to output sound required in performing audio, video, navigation, and other additional functions.

The speaker 30 (30L, 30R) may be disposed in front of each of the driver's seat 22L and the passenger seat 22R in FIG. 3, without being limited thereto. For example, speakers may be disposed in various positions inside the vehicle 100.

A steering wheel 27 may be provided on the dashboard 26 in front of the driver's seat 22L, and a key hole 28 may be formed in an area near the steering wheel 27 for a remote control device, e.g., a key fob, to be inserted thereto. The remote control device may be inserted into the key hole 28 to turn on/off an ignition of the vehicle 100.

Furthermore, an ignition button 29 may be disposed on the dashboard 26 to start/stop the engine of the vehicle 100.

Meanwhile, the vehicle 100 may also include an air conditioner configured to perform heating or cooling and release heated or cooled air through air vents 21 to control the temperature inside the vehicle 100.

The air vents 21 (21L, 21R) are disposed in front of the driver's seat 22L and the passenger seat 22R in FIG. 3, without being limited thereto. For example, the air vents 21 may be provided at various positions inside the vehicle.

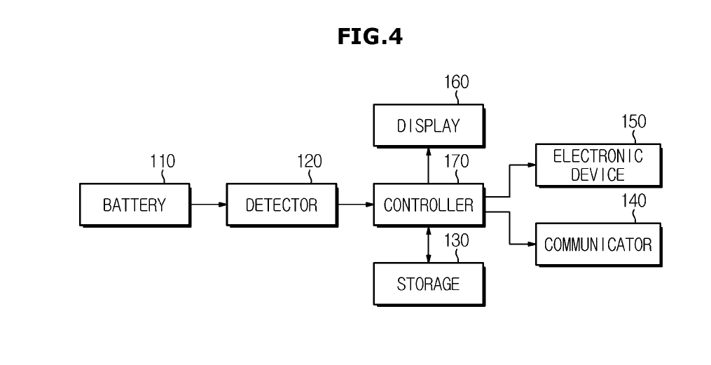

FIG. 4 is a block diagram illustrating some components of the vehicle according to an embodiment.

Referring to FIG. 4, in embodiments, the vehicle 100 may include a battery 110 configured to supply power to one or more electronic devices 150 provided in the vehicle 100. For example, the battery provide power to a detector 120 configured to sense a state of the battery 110, a storage 130 configured to store information of the vehicle 100 and the battery 110, a communicator 140 configured to perform communication with a remote control device, the display 160 configured to display information of the vehicle 100 and the battery 110, and a controller 170 configured to control an operation of the communicator 140 and the electronic device 150 based on the result sensed by the detector 120.

In embodiments, the detector 120 may periodically sense the state of the battery 110 provided in the vehicle 100. Particularly, when the vehicle 100 is powered off, the detector 120 may periodically sense the state of the battery 110 and transmit the sensed result to the controller 170.

The state of the battery 110 may include the amount of stored power of the battery (power value), an elapsed time after the vehicle 100 is stopped, and the amount of current consumed in the battery 110 in real time.

Accordingly, the detector 120 may include various circuits and devices capable of sensing a voltage change of the battery 110. For example, a level detector circuit may be configured to sense the voltage change of the battery 110 in real time. However, the present disclosure is not limited to this, but may be applied to a case where the voltage of the battery 110 can be sensed in real time.

In embodiments, the storage 130 may store various information related to the vehicle 100, the battery 110, and the electronic device 150. In particular, the storage 130 may include information on the maximum power that can be stored in the battery 110, and the amount of current consumed when the electronic device 150 is operated.

The information stored in the storage 130 may be transmitted to the controller 170. The controller 170 may control the operation of the communicator 140 and the electronic device 150 based on the information received from the storage 130 and the result received by the detector 120.

Therefore, the storage 130 may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random access memory (RAM), or a storage medium, such as hard disk drive (HDD) or compact disk (CD) ROM, without being limited thereto. The storage 130 may be a memory implemented with a chip separate from a processor, which will be described later, in relation to the controller 170, or may be implemented integrally with the processor in a single chip.

In embodiments, the communicator 140 may transmit and receive signals to and from the remote control device that can remotely operate the vehicle 100. The communicator 140 may further transmit the result of transmission and reception to the controller 170.

The communicator 140 may then be configured to communicate with the external server in various methods. For example, the communicator 140 may be configured to transmit and receive information by using various methods, such as radio frequency (RF), wireless fidelity (Wi-Fi), Bluetooth, Zigbee, near field communication (NFC), ultra-wide band (UWB) communication, etc.

Although the communicator 140 is shown as a single component to transmit and receive signals in FIG. 4, it is not limited thereto, but may be implemented as a separate transmitter for transmitting the signals and as a receiver for receiving the signals.

In embodiments, the display 160 may display driving information of the vehicle 100 and various types of information regarding the battery 110, and the displayed screen may be controlled by the controller 170.

The display 160 may include a display panel to represent the above-described information, and the display panel may employ a cathode ray tube (CRT), a display panel, a liquid crystal display (LCD), a light emitting diode (LED) panel, an organic LED panel (OLED), a plasma display panel (PDP), a field emission display (FED) panel, etc.

In embodiments, the display 160 may implement a touch screen display configured to receive a user input by touch. In this case, the display 160 may include a display panel configured to display an image and a touch panel configured to receive a touch input.

In embodiments, the controller 170 may control various devices provided in the vehicle 100. Particularly, the controller 170 may determine whether the state of the vehicle 100 satisfies a second predetermined condition when the state of the battery 110 satisfies a first predetermined condition. When determined that the state of the vehicle 100 satisfies the second condition, the controller 170 may stop the operation of the communicator 140. In embodiments, the second condition is different from the first condition.

In embodiments, the first condition may be a condition under which a discharge risk of the battery 110 may occur. The first condition may be generated based on at least one of the remaining amount of the battery 110, the elapsed time after the power of the vehicle 100 is turned off, and the amount of the current flowing in real time after the power of the vehicle 100 is turned off.

For example, when the remaining amount of the battery 110 falls to 75% or less and the power of the vehicle 100 is turned off, four days have elapsed, or when the remaining amount of the battery 110 falls to 65% or less and the power of the vehicle 100 is turned off, seven days have elapsed, it may be determined that the first condition is satisfied. In addition, when the amount of current consumed in real time in the state where the power of the vehicle 100 is turned off is 1 A or more, it may be determined that the first condition is satisfied. In embodiments, when the amount of current flowing out from the battery in real time in the state where the power of the vehicle 100 is turned off equals or is more a certain amount (for example, 1 A or more), it may be determined that the first condition is satisfied.

The remaining amount of the battery 110 included in the first condition and the elapsed time after the power of the vehicle 100 is turned off are not limited to the above-described examples, and may be variously set according to the user's environment.

The controller 170 may determine whether the state of the vehicle 100 satisfies the second condition when the state of the battery 110 satisfies the first condition.

In embodiments, the second condition may be a condition for determining whether the state of the vehicle 100 corresponds to a long-term parking state, not a simple or short stop state. Thus, the second condition may be generated based on at least one of the power state of the vehicle 100, the state of the remote control device, and the state of the door 15.

Particularly, the controller 170 may determine that the second condition is satisfied when the power of the vehicle 100 is in an accessory (ACC) state OFF and ignition 1 (IGN1) and ignition 2 (IGN2) states are OFF, or the controller 170 may determine that the second condition is satisfied when the state of the remote control device is in a locked state and the door 15 is closed.

In addition, the controller 170 may determine that the second condition is satisfied when the power of the vehicle 100 is in the ACC state OFF, the ignition 1 (IGN1) and ignition 2 (IGN2) states are OFF, the state of the remote control device is in a locked state, and the door 15 is closed.

In embodiments, the ACC state may refer to a state in which the power of the vehicle 100 is turned on, but the ignition is not turned on. Particularly, the ACC state may refer to a state in which the electronic devices provided in the vehicle 100, such as an audio system, a clock, etc., are operated while the engine of the vehicle 100 is not operated.

The ignition 1 may include the electronic device configured to drive the vehicle 100 and a transmission, and the ignition 2 may include external electronic devices that consume a lot of current, such as a light, a hot wire, a power window, a wiper, etc.

In embodiments, the controller 170 may determine that the vehicle 100 is in the long-term parked state and that there is a possibility of discharging the battery 110 when the second condition is satisfied and the power of the communicator 140 communicating with the electronic devices 150 may be turned off.

In embodiments, the controller may turn off the communicator 140. In embodiments, the communicator 140 may include a CAN communication, which is communication means within the vehicle 100.

In general, when an external signal is received while the vehicle 100 is stopped, all the electronic devices may be turned on, thereby consuming unnecessary current. However, the vehicle 100 according to the embodiment may turn off all CAN communications connected to the electronic devices, when the state of the vehicle 100 satisfies the second condition, thereby minimizing unnecessary current or preventing unnecessary current from flowing by turning on the electronic device even when receiving the signal from the external device.

In embodiments, the controller 170 may control the operation of the electronic device 150 while turning off the communicator 140 that communicates with the electronic device 150 when the second condition is satisfied. In one embodiment, the controller 170 may control the operation of the electronic devices 150 after the communicator 140 is turned off by the control command from the controller 170 when the second condition is satisfied. In another embodiment, the controller 170 may control the operation of the electronic devices 150 at the same time when the communicator 140 is turned off by the control command from the controller 170 when the second condition is satisfied.

Particularly, the controller 170 may control different types of electronic devices according to the state of the battery 110.

For example, the power of the electronic devices belonging to a first group may be turned off if there is a possibility of discharge of the battery 110 but the degree of danger is not high, and the power of the electronic devices belonging to a second group may be turned off if there is a possibility of discharging the battery 110 exists and the degree of danger is high.

The electronic devices belonging to the first group may include short-term load devices and the electronic devices 150 belonging to the second group may include long-term load devices. The short-term load devices may refer to the electronic devices 150 that are relatively infrequently used when the vehicle 100 is stopped, and the long-term load devices may refer to the electronic devices 150 that are relatively frequently used when the vehicle 100 is stopped. In embodiments, the long-term load devices is used more frequently than the short-term load devices when the vehicle is stopped.

Accordingly, in embodiments, the controller 170 may control the electronics devices 150 more efficiently by turning off the power of the first group of the electronic devices 150 that are used less frequently when the sensed voltage of the battery 110 is relatively high, and turning off the power of the second group of the electronic devices 150 that are used frequently when the sensed voltage of the battery 110 is relatively low.

In addition, the distinction criterion between the first group and the second group is not limited to the above-described criteria, and various devices may be classified by various criteria according to the use environment.

In embodiments, the controller 170 may also determine that the user intends to use the vehicle 100 when the door 15 of the vehicle 100 is unlocked by the remote control device or the door 15 of the vehicle 100 is opened after the power of the electronic device 170 is turned off, and the power of the communicator 140 may be turned on.

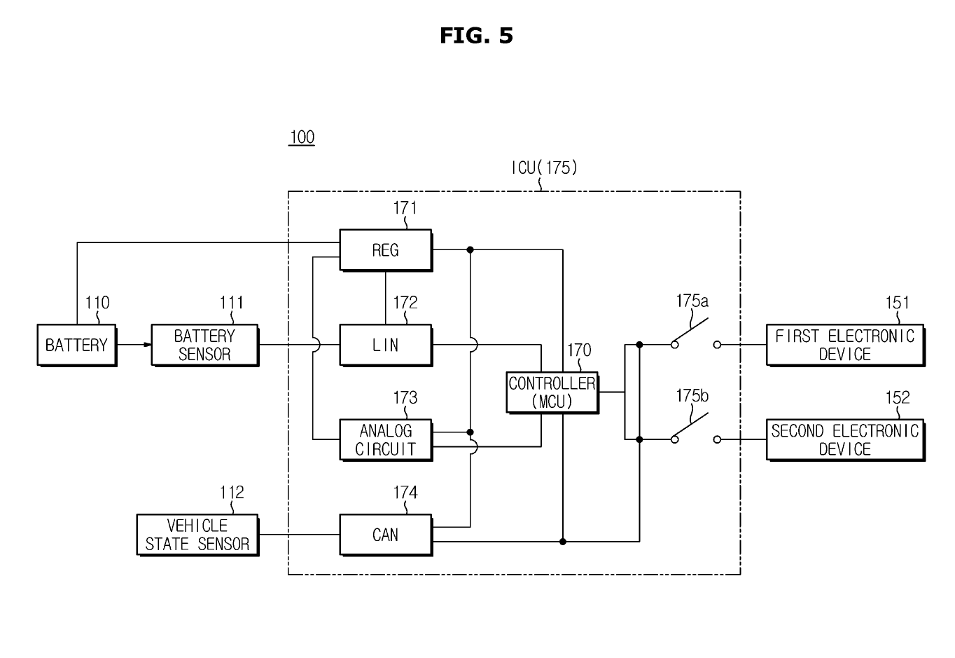

FIG. 5 is a block diagram illustrating some components of the vehicle 100 according to another embodiment.

Referring to FIG. 5, the vehicle 100 may include the battery 110, a battery sensor 111 configured to sense the battery 110, and an interface control unit (ICU) 175 including the controller 170 configured to control electronic devices 151 and 152 by controlling a switch based on the result received from a vehicle state sensor 112.

In embodiments, the battery sensor 111 and the vehicle state sensor 112 may be included in the detector 120 described in FIG. 4. The battery sensor 111 may sense the state of the battery in real time and the vehicle state sensor 112 may sense the state of the vehicle in real time.

Particularly, the vehicle state sensor 112 may sense that the power source of the vehicle 100 is in the accessory (ACC), the ignition 1 (IGN1) and ignition 2 (IGN2) states, and the state of the remote control device and the door 15 in real time.

In embodiments, the battery sensor 111 may sense the consumption current and the phase of the battery 110 in real time when the CAN communication is turned off after the power of the vehicle 100 is turned off. The battery sensor 111 may be a slave structure of LIN (Local Interconnect Network) communication.

The battery sensor 111 may operate a LIN bus 172 of the ICU 175 when there is a change in the state of the battery 110 while the ICU 175 is turned off. An analog circuit 173 may be driven by the voltage generated by the LIN bus 172 and the voltage may be supplied to the controller 170 by driving the analog circuit 173.

When the voltage is input, the ICU 175 may sense the state of the vehicle 100. Particularly, the ICU 175 may determine whether the state of the vehicle 100 is in the accessory (ACC), the ignition 1 (IGN1) and ignition 2 (IGN2) states, and whether the CAN communication is active.

All of the CAN communications in the vehicle 100 may be turned off to reduce the current consumption and the dark current when the state of the vehicle 100 is not in the ACC state but in the ignition 1 and ignition 2 states and the CAN communication is inactivated.

In embodiments, the ICU 175 may turn off the power of the first electronic device 151 when it is determined that the state of the battery 110 satisfies the first condition that the discharge is possible but the degree of danger is not high.

The first electronic device 151 may be the same as the electronic devices belonging to the first group described above and generally relatively less frequently used electronic devices may be included in the first electronic device 151 when the vehicle 100 is stopped.

In addition, the ICU 175 may turn off the power of the second electronic device 152 when it is determined that the state of the battery 110 satisfies the second condition.

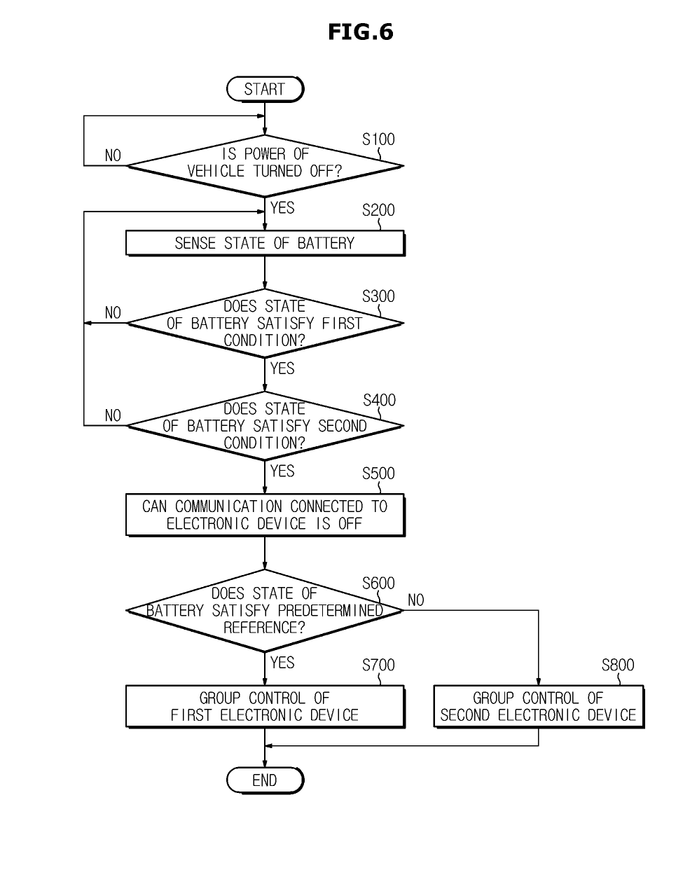

The second electronic device 152 may be the same as the electronic devices belonging to the second group described above and may include a relatively common type of the electronic devices 150 when the vehicle 100 is stopped. The first condition and the second condition will be described in detail with reference to FIG. 6.

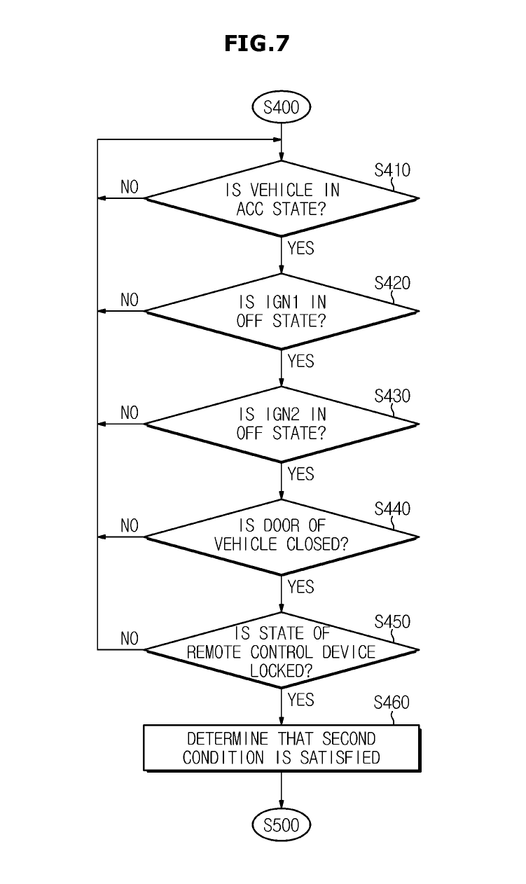

FIG. 6 is a flowchart illustrating an operation process of the vehicle 100 according to an embodiment, and FIG. 7 is a flowchart illustrating an operation process of the vehicle 100 according to another embodiment.

Referring to FIG. 6, the vehicle 100 may determine whether the power of the vehicle 100 is turned off (S100).

When the power of the vehicle 100 is turned off, the vehicle 100 may sense the state of the battery 110 and may determine that the state of the battery 110 satisfies the first condition (S200, S300).

The first condition may be a condition under which a discharge risk of the battery 110 may occur. The first condition may be generated based on at least one of the remaining amount of the battery 110, the elapsed time after the power of the vehicle 100 is turned off, and the amount of the current flowing in real time after the power of the vehicle 100 is turned off.

For example, when the remaining amount of the battery 110 falls to 75% or less and the power of the vehicle 100 is turned off, four days have elapsed, or when the remaining amount of the battery 110 falls to 65% or less and the power of the vehicle 100 is turned off, seven days have elapsed, it may be determined that the first condition is satisfied.

In addition, when the amount of current consumed in real time in the state where the power of the vehicle 100 is turned off is 1 A or more, it may be determined that the first condition is satisfied. The first condition is not limited to the above-described examples, and may be set to various values.

The controller 170 may determine whether the state of the vehicle 100 satisfies the second condition when the state of the battery 110 satisfies the first condition.

When the state of the battery 110 satisfies the first condition, the vehicle 100 may determine whether the state of the vehicle 100 satisfies the second condition (S400).

The second condition may be a condition for determining whether the state of the vehicle 100 corresponds to the long-term parking state, not the simple stop state. Thus, the second condition may be generated based on at least one of the power state of the vehicle 100, the state of the remote control device, and the state of the door 15.

Referring to FIG. 7, the vehicle 100 may determine whether the state of the vehicle 100 is in the ACC Off state (S410). When the state of the vehicle 100 is in the ACC Off state, the vehicle may determine whether the states of the ignition 1 (IGN1) and ignition 2 (IGN2) are in the OFF state (S420, S430).

When all the ignition states are off, the vehicle 100 may determine that the vehicle 100 is parked. However, since the user may have parked the vehicle 100 for a while, the vehicle 100 may further determine whether the door of the vehicle 100 is closed or the state of the remote control device is in the locked state (S440, S450).

When S440 and S450 are satisfied, the vehicle 100 may determine that the vehicle 100 is in the parked state for a long period of time, and in this case, it may be determined that the second condition is satisfied.

Although the processes of S410, S420, S430, S440, and S450 are sequentially described in FIG. 7, the present disclosure is not limited thereto, and the steps may be performed simultaneously, and the sequence may be variously changed.

Returning back to FIG. 6, when the state of the vehicle 100 satisfies the second condition, there is a possibility of discharging the battery 110, so that the vehicle 100 may turn off all the CAN communications connected to the electronic device 150 (S500).

In general, when an external signal is received while the vehicle 100 is stopped, all the electronic devices may be turned on, thereby consuming unnecessary current. However, the vehicle 100 according to the embodiment may turn off all CAN communications connected to the electronic devices, when the state of the vehicle 100 satisfies the second condition, thereby minimizing unnecessary power consumption or preventing the unnecessary current from being used.

Thereafter, the vehicle 100 may determine whether the state of the battery 110 satisfies a predetermined range, and control the first electronic device group when the predetermined range is satisfied. Also, the vehicle 100 may control the second electronic device group when the predetermined range is not satisfied (S600 to S800).

Accordingly, the predetermined range may refer to a degree of danger that the possibility of discharging the battery 110 exists, but the risk is still low.

For example, the remaining amount of the battery 110 may be between 65% and 75%, or 4 to 7 days may have elapsed after the power source of the vehicle 100 is turned off.

Therefore, when the predetermined range is satisfied, the possibility of discharge of the battery 110 is not high yet, so that the vehicle may control the first electronic device group belonging to the short-term load devices having been relatively infrequently used. Otherwise, the vehicle may control the second electronic device group belonging to the long-term load devices having been relatively frequently used.

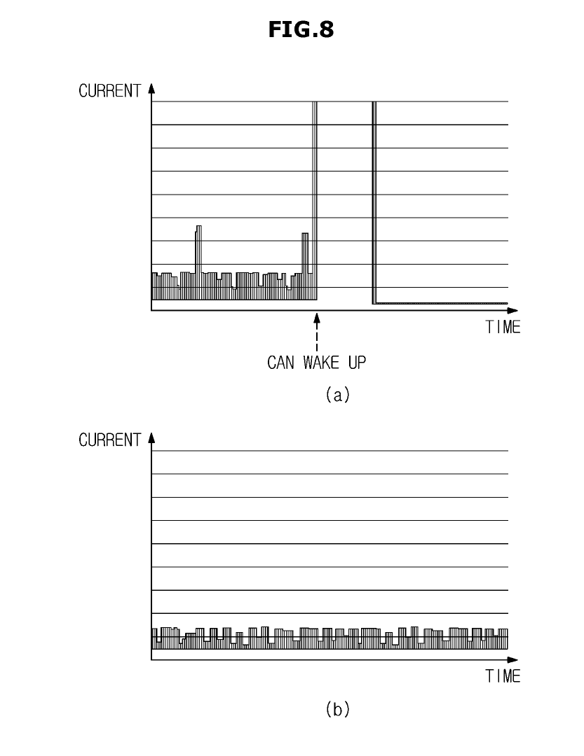

FIG. 8 is a view comparing the dark current flowing in the vehicle according to an embodiment and the typical vehicle.

In the typical vehicle, when the external signal is received in the state where the vehicle is stopped, all the electronic devices are switched to the on state, so that the amount of current is instantaneously increased as shown in FIG. 7(a). However, when the vehicle 100 according to the embodiment satisfies the second condition, the vehicle 100 disconnects all CAN communications connected to the electronic devices, there is an effect that the amount of current flowing instantaneously even when the signal is received from the external device is small and the amount of current used may be reduced without the need for what.

The components of the vehicle 100 and the control method of the vehicle 100 according to the embodiment have been described thus far.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

As is apparent from the above description, the vehicle according to the embodiments of the present disclosure can have an effect of increasing the battery life of the vehicle and preventing or minimizing the battery discharge issue by reducing the unnecessary power consumption that may occur in the vehicle while stopped.

Although a few embodiments have been shown and described with reference to the accompanying drawings, it will be apparent to those skilled in the art that various modifications and variations can be made from the above descriptions. For example, appropriate results may be achieved even when the described techniques are performed in an order different from the described method, and/or the described elements such as systems, structures, devices, circuits, and the like are coupled or combined in forms other than the described method, or substituted or switched with other elements or equivalents. Therefore, other embodiments and equivalents to the claimed subject matter are within the scope of the appended claims.

What is claimed is:

1. A vehicle comprising:
a battery;
a sensor configured to sense a state of the battery and the vehicle;
at least one electronic device configured to receive power from the battery;
a communicator configured to communicate with the electronic device; and
a controller configured to determine whether the state of the vehicle satisfies a second condition when the state of the battery satisfies a first condition, and stops the operation of the communicator when determined that the state of the vehicle satisfies the second condition.

2. The vehicle according to claim 1, wherein the controller is configured to turn off the power of the electronic device.

3. The vehicle according to claim 1, wherein the controller is configured to stop different types of the electronic devices according to the state of the battery.

4. The vehicle according to claim 1, wherein the sensor is configured to sense the state of the battery when the power of the vehicle is turned off.

5. The vehicle according to claim 4, wherein the controller is configured to determine whether the second condition is satisfied based on at least one selected from the group consisting of a power state of the vehicle, a state of a remote control device, and a state of a door.

6. The vehicle according to claim 5, wherein the controller is configured to determine that the vehicle satisfies the second condition when the vehicle is not in an accessory (ACC) state, and ignition 1 (IGN1) and ignition 2 (IGN2) states are OFF.

7. The vehicle according to claim 5, wherein the controller is configured to determine that the vehicle satisfies the second condition when the state of the remote control device is in a locked state and the door is closed.

8. The vehicle according to claim 5, wherein the controller is configured to determine that the vehicle satisfies the second condition when the vehicle is not in an accessory (ACC) state, ignition 1 (IGN1) and ignition 2 (IGN2) states are OFF, the state of the remote control device is in a locked state, and the door is closed.

9. The vehicle according to claim 1, wherein the first condition is configured to be generated based on at least one selected from the group consisting of the remaining amount of the battery, an elapsed time after the power of the vehicle is turned off, and the amount of a current flowing after the power of the vehicle is turned off.

10. The vehicle according to claim 2, wherein the controller is configured to turn on the power of the communicator when a door of the vehicle is unlocked by a remote control device of the vehicle or when the door of the vehicle is opened.

11. A control method of a vehicle including at least one electronic device that receives power from a battery, the method comprising:
sensing a state of the battery;
determining if the state of the battery satisfies a first condition;
sensing a state of the vehicle when determined that the state of the battery satisfies a first condition;
determining if the state of the vehicle satisfies a second condition; and
preventing communication with the electronic device when determined that the state of the vehicle satisfies a second condition.

12. The method according to claim 11, further comprising:
stopping an operation of the electronic device when the sensed state of the battery is included in a predetermined reference.

13. The method according to claim 12, wherein the stopping of the operation of the electronic device comprises:
stopping different types of the electronic devices according to the state of the battery.

14. The method according to claim 11, wherein the sensing of the state of the battery comprises:
sensing the state of the battery when the power of the vehicle is turned off.

15. The method according to claim 14, wherein the determining of the state of the vehicle satisfying the second condition comprises:
determining whether the second condition is satisfied based on at least one of the power state of the vehicle, a state of a remote control device, and/or a state of a door.

16. The method according to claim 15, wherein the determining of the state of the vehicle satisfying the second condition comprises:
determining that the vehicle satisfies the second condition when the vehicle is not in an accessory (ACC) state, and ignition 1 (IGN1) and ignition 2 (IGN2) states are OFF.

17. The method according to claim 15, wherein the determining of the state of the vehicle satisfying the second condition comprises:
determining that the vehicle satisfies the second condition when the state of the remote control device is in a locked state and the door is closed.

18. The method according to claim 15, wherein the determining of the state of the vehicle satisfying the second condition comprises:
determining that the vehicle satisfies the second condition when the vehicle is not in an accessory (ACC) state, ignition 1 (IGN1) and ignition 2 (IGN2) states are OFF, the state of the remote control device is in a locked state, and the door is closed.

19. The method according to claim 11, wherein the first condition is configured to be generated based on at least one selected from the group consisting of the remaining amount of the battery, an elapsed time after the power of the vehicle is turned off, and the amount of a current flowing after the power of the vehicle is turned off.

20. The method according to claim 12, further comprising:
turning on the power of the communicator when a door of the vehicle is unlocked by a remote control device of the vehicle or when the door of the vehicle is opened.
